(19) United States
(12) Patent Application Publication
(10) Pub. No.: US 2010/0140528 A1
(43) Pub. Date: Jun. 10, 2010

(54) VALVE CONSTRUCTION

(76) Inventor: William Ross McLennan, Perkiomenville, PA (US)

Correspondence Address: MITCHELL A. SMOLOW, 720 HAMPTON ROAD, SHAVERTOWN, PA, 18708, US

(21) Appl. No.: 12/702,650

(22) Filed: Feb. 9, 2010

Related U.S. Application Data
(63) Continuation-in-part of application No. 11/825,522, filed on Jul. 5, 2007.
(60) Provisional application No. 61/151,766, filed on Feb. 11, 2009.
(60) Provisional application No. 60/818,384, filed on Jul. 5, 2006.

(51) Int. Cl. F16K 51/00; F16J 15/32

(52) U.S. Cl. 251/366; 277/549; 277/309

(57) ABSTRACT

A valve assembly for sealing and control of a fluid, gas or dry material. The valve assembly includes a seal assembly having a hollow seal, a related valve body, and an actuator assembly. The valve body has a generally circular internal cavity with the seal assembly having a generally tubular solid wall defined tip having a flexible wall portion containing a seal element used to seal against both static and dynamic forces. An actuator assembly actuates the seal assembly. The seal assembly is situated coaxially within the valve internal cavity and thereby defines an internal fluid passageway within the valve body.

### CROSS REFERENCE TO RELATED APPLICATIONS

This application claims benefit of U.S. Provisional Application No. 61/151,766 filed Feb. 11, 2009 and is a continuation in part of U.S. application Ser. No. 11/825,522 filed Jul. 5, 2007 which claims the benefit of U.S. Provisional Application No. 60/818,384 filed Jul. 5, 2006, of all which are incorporated by reference in their entirety.

### FIELD OF THE INVENTION

The present invention relates to fluid and gas piping and containers and more particularly to an improved valve construction for use therewith.

### BACKGROUND OF THE INVENTION

Manufacturing processes such as those used in the biotech, pharmaceutical and semiconductor industries require a demanding valve which provides for secure closure and also for clean-in-place and steam sterilization. The simple closures currently in use or already known have proven unsatisfactory for these uses.

Common non-pinching valve designs used in these industries are generally based upon the Saunders Diaphragm Valve, described in U.S. Pat. No. 1,992,043. The Saunders Valve, also known as the weir style diaphragm valve, was first employed in the sanitary production of milk and other consumable food fluids. It proved to be both cleanable and sanitary. This valve was readily adapted by the aforementioned industries and until recently was considered by many to be the best available technology.

Known improvements to the original concept include many valves currently gaining popularity for specific applications, such as valves placed on tank bottoms for draining, and at various piping and tank locations for product sampling. For example, in U.S. Pat. No. 5,277,401, Butler teaches a tank bottom configuration using a weir style diaphragm.

Newer devices that use diaphragm technology to provide the valve seal movement have moved away from the weir style to avoid several inherent disadvantages in the original design. An example is U.S. Pat. No. 4,819,691 wherein Lofgren teaches a generally “L” shaped valve using a diaphragm for movement of an integrally molded valve seat. The “L” configuration is an improved application for a tank bottom or side outlet in a tank or piping application over the inline weir style. This technology also improves the “dead leg” condition associated with a volume of fluid occurring inside the valve upstream of the closed valve seat.

Rasnow teaches an improvement in U.S. Pat. No. 6,123,320 wherein the manufacturing complexity of the valve is reduced compared to the weir style valve. Rasnow also claims to reduce an industry recognized problem with the weir style diaphragm wherein the perimeter of the diaphragm seal can open slightly during certain uses, in particular during application of steam for sterilization, thereby resulting in a small area of trapped contamination.

Similar devices attempt to solve this problem by either employing a bellows rather than a diaphragm to permit the valve movement or employing a diaphragm in combination with a bellows. See, for example, U.S. Pat. Nos. 4,836,236 and 5,152,500.

In all these aforementioned improved devices the valve body has a bowl below the inlet valve seat and a side port for communication of the fluid out of the bowl. The valve seal is provided by a generally rigid movable bulbous end which seals against the valve seat and is positioned above an integrally formed bellows or diaphragm portion. The integrally formed bellows or diaphragm portion provides for valve seat movement with an integrally formed open end for providing sealable attachment to the valve body.

In a departure from these popular designs, Ottung in U.S. Pat. No. 5,246,204 teaches use of a one-piece generally circular and stretchable elastomeric valve seal specifically for use in sampling in pharmaceutical production. This device eliminates the bowl associated with the aforementioned devices thereby reducing the internal volume. The resultant savings in fluid volume is particularly important in biotech and pharmaceutical applications where the cost per fluid ounce can be significant.

The smaller internal volume and associated reduction of surface area also reduces waste of the process fluids or gases that in the case of pharmaceuticals can be costly, reduces consumption of cleaning fluids and improves the overall sterility of the valve construction. However, valves incorporating the Ottung design have limited performance in a vacuum application and also have a generally lower cycle life than most of the other aforementioned valves. Further, the use of elastomers in fluid or gas contact has become less accepted in many industries due to stress relaxation and time dependent creep of the base elastomers, resulting in decayed performance over time.

Accordingly, there is still a continuing need for improved valve designs. The present invention fulfills this need and further provides related advantages.

### BRIEF SUMMARY OF THE INVENTION

The present invention relates to an improved valve seal for use with fluid and gas piping and containers. The object of this invention is to provide an improvement over the existing valves wherein the internal cavity has reduced complexity, with fewer surfaces and cavities wetted by the communicated materials.

Secondarily, this invention provides an improvement over the existing devices in that it is of a less complicated construction reducing associated manufacturing costs. This improvement is particularly suited for applications where the communicated materials are very costly, easily contaminated, or in use in a process that requires regular draining, cleansing and sterilization of the internal passageways, such as in, for example, pharmaceutical production

The present invention teaches a construction that also results in a minimal amount of fluids entrapped in a dead leg or stationary zone. This is very important in, for example, the pharmaceutical industry where dead leg conditions are hard to keep clean, sterilize and result is product loss.

In a preferred embodiment a valve assembly for sealing and control of a fluid, gas or dry material comprises a seal assembly having a hollow seal, a related valve body, and an actuator assembly. The valve body comprises a generally circular internal cavity with the seal assembly having a generally tubular solid wall molded defined tip used to seal against both static and dynamic forces. An actuator assembly actuates the seal assembly. The seal assembly is situated coaxially within the valve internal cavity and thereby defines an internal fluid passageway within the valve body.

Other features and advantages of the present invention will be apparent from the following more detailed description of the preferred embodiments, taken in conjunction with the accompanying drawings which illustrate, by way of example, the principles of the invention.

### BRIEF DESCRIPTION OF THE DRAWINGS

The accompanying drawings are included to provide a further understanding of the present invention. These drawings are incorporated in and constitute a part of this specification, illustrate one or more embodiments of the present invention, and together with the description, serve to explain the principles of the present invention.

FIG. 1 is an isometric exploded view of a preferred embodiment.

FIG. 2a is an isometric view of the body.

FIG. 2b is an isometric view of an alternate body embodiment.

FIG. 2c is an isometric view of a multiple valve manifold.

FIG. 3 is an isometric exploded view of the handle assembly.

FIG. 4 is an isometric exploded view of the seal assembly.

FIG. 5 is a cross-sectional view of a valve assembly.

Other features and advantages of the present invention will be apparent from the following more detailed description of the preferred embodiments, taken in conjunction with the accompanying drawings which illustrate, by way of example, the principles of the invention.

### DETAILED DESCRIPTION OF THE INVENTION

As required, detailed embodiments of the present invention are disclosed; however, it is to be understood that the disclosed embodiments are merely exemplary of the invention that may be embodied in various forms. The figures are not necessary to scale, and some features may be exaggerated to show details of particular components. Therefore, specific structural and functional details disclosed are not to be interpreted as limiting, but merely as a basis for the claims and as a representative basis for teaching one skilled in the art to variously employ the present invention. Where possible, like reference numerals have been used to refer to like parts in the several alternative embodiments of the present invention described herein.

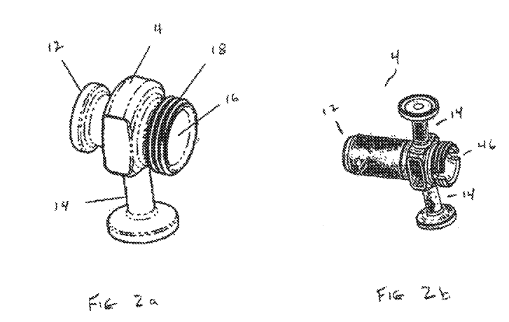

The present invention describes a valve assembly utilizing a novel valve seal. Not depicted in the drawings are mechanisms used to operate the valve shaft movement such as an air cylinder or a fast acting cam handle. Multiple valve configurations are common in, for example, the biotech and pharmaceutical industry and while the main improvement of the present invention is shown in the exemplar valve body, other valve body configurations are contemplated such as, for example, those shown in FIG. 2b.

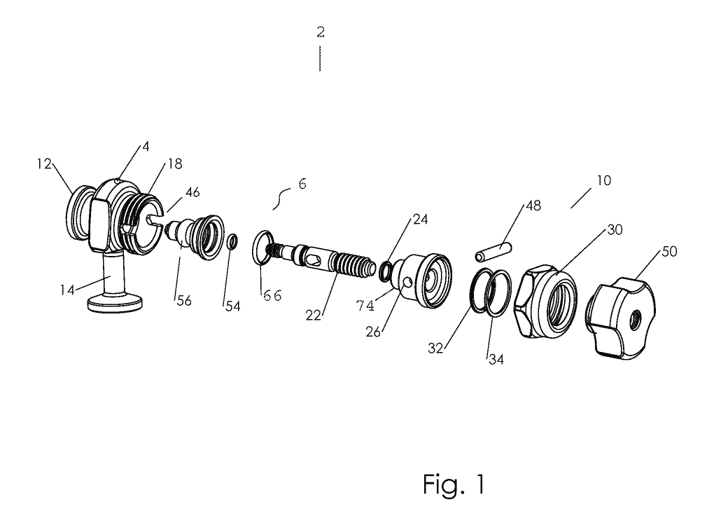

Referring now to the FIG. 1, in a preferred embodiment, the major structural groupings of the valve assembly 2 include the body 4, seal assembly 6, and actuator assembly 10.

The body 4 (FIGS. 2a-2c) has an inlet 12 and outlet 14 each providing for attachment of the valve assembly 2 to an associated piping or tank (not shown). The body 4 has a generally rounded, for example, a circular, internal cavity 16 and a receiving element, for example, a threaded body collar 18 used to threadably receive the actuator assembly threaded collar 30. Optionally, threaded body collar 18 is slotted 46 to translationally receive anti-rotationally engaged dowel pin 48, further described below. The body outlet configuration is not limited to a single outlet, but multiple outlet configurations, as required by manufacturing process needs, exemplified by FIG. 2b and the multiple valve manifold of FIG. 2c are also contemplated.

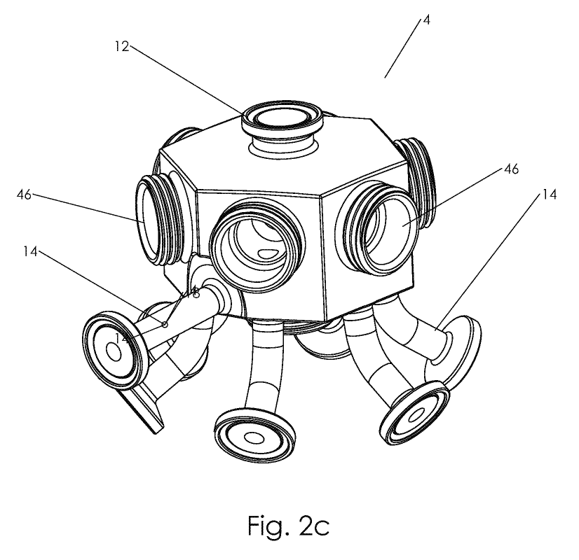

The actuator assembly 10 (FIG. 3) comprises an actuator 50, for example a handle, provided with a threaded internal chamber 20 to threadably receive seal assembly shaft second threaded end 22 and seal assembly secondary stem seal, for example, o-ring 24. A seal assembly retainer 26 having two opposing orifices 44 for receiving dowel pin 48 fits within the generally circular internal cavity 16 and compresses and retains the seal assembly 6 into the body 4, described in detail below. A retaining ring 32 and actuator bearing 34 are positioned over actuator stem 36 and held within seal assembly retainer 26 which in turn is held within actuator assembly collar 30.

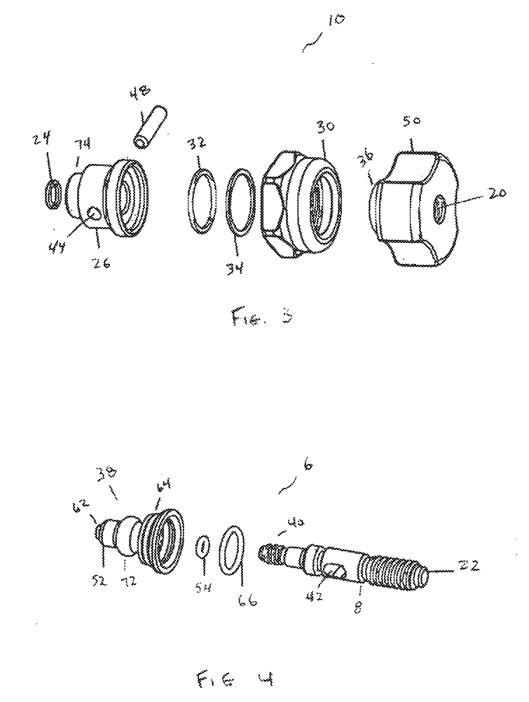

The seal assembly 6 (FIG. 4) comprises a shaft 8 having the above described second threaded end 22 and an opposite first threaded end 40 with an anti-rotation oblong transverse channel 42 located therebetween for receiving the dowel pin 48. The first threaded end 40 is preferably tapered. The oblong shape of the transverse channel 42 serves to limit the opening and closing of valve assembly 2, described in detail below. An internally threaded tip 38 fabricated from a thermoplastic or thermoset material, for example, Polytetrafluoroethylene (“PTFE”) or TFM, a thermally resistant form of PTFE, of predefined shape is an integrally defined single piece threaded over the shaft first threaded end 40. Preferably, the internally threaded tip 38 is hollow. In a preferred embodiment, the internally threaded tip 38 is machined.

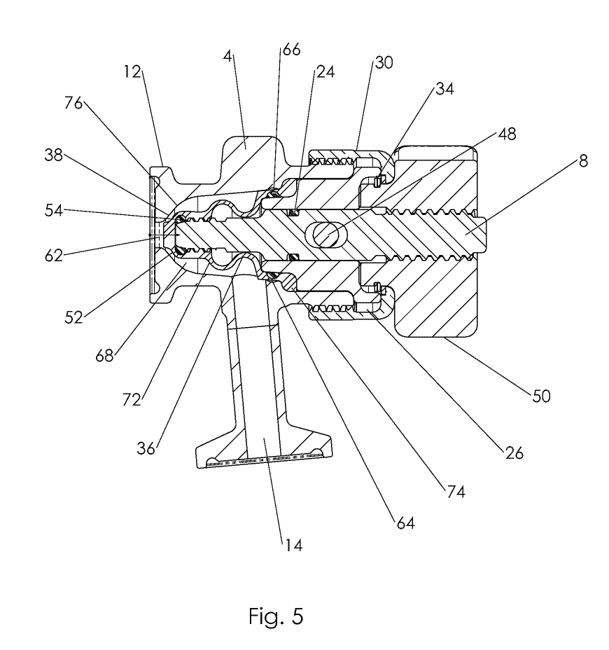

Turning to FIGS. 4 and 5, the internally threaded integrally defined tip 38 is a shaped, for example, a conically shaped in cross section, flexible wall portion 52 occurring before the tip end 62. Preferably, tip end 62 is of smaller diameter than flexible wall portion 52. The thin flexible wall portion 52 is fabricated to create a space between it and the shaft 8 in order to accept and retain a seal element, for example, a tip o-ring 54 which when inserted, butts against the smaller diameter tip end 62.

The defined tip 38 comprises a body sealing wall 64 that upon valve closure sealingly engages within the body 4 at the outlet 14. The defined tip 38 must be able to expand and compress longitudinally as shaft 8 is mechanically engaged. In a preferred embodiment, this is accomplished by, for example, adding at least one corrugation 72 to the defined tip 38. Protruding ring 74 at the open end of the defined tip 38 is sandwiched between internal cavity 16 and the seal retainer 26 and is used to hold the seal assembly 6 in place during movement and pressurization of the valve internals.

The seal assembly retainer 26 fits within the internal cavity 16 and upon actuation compresses and retains the seal assembly 6 into the body 4. A defined tip o-ring 66 is seated within the open end of the defined tip 38 and sealingly engages end 74 (FIGS. 1 and 3) of the seal assembly retainer 26. The seal assembly 6 is situated coaxially within the internal cavity 16 and thereby defines an internal fluid passageway 68 within the valve body 4 which is readily cleanable and sterilizable. A seat surface 76 is situated at the inlet end of the internal cavity 16 to seatingly and sealingly receive the defined tip 38.

In use, the novel valve mechanism operates as follows. In transitioning from an open to a closed state, when the actuator handle 50 is rotated, the threaded internal chamber 20 causes the shaft 8 to move axially inward within the actuator handle 50 and valve body 4. The anti-rotation dowel 48, anti-rotation oblong transverse channel 42, and optional body collar slot 46 prevents shaft 8 rotation and possible resultant shaft disengagement from the defined tip 38. The anti-rotation oblong transverse channel 42 also limits total shaft travel. In the fully open position, the anti-rotation dowel 48 is in contact with the actuator assembly 10 end of the oblong transverse channel 42 and conversely, in the fully closed position, the anti-rotation dowel 48 is in contact with the body 4 end of the oblong transverse channel 42, thereby limiting shaft 8 travel.

As the shaft 8 travels within the valve body 4 to the fully closed position, the actuator handle 50 places increasing pressure on the seal retainer 26 causing it to place increasing pressure on the defined tip 38. As the pressure increases, seal assembly retainer 26 travels within the internal cavity 16 and compresses and retains the seal assembly 6 into the body 4 causing the seal tip o-ring 54 to compress in thickness and expand in diameter within the conically shaped flexible wall portion 52 as the smaller diameter tip end 62 is compressed against the seat surface 76 situated at the inlet end of the internal cavity 16, thereby creating the seal. At the same time, defined tip conical portion 56 which is coaxially contained within the internal cavity 16 creates self drainage within the body 4, thereby draining the passageway 68 and preventing any dead legs or stationary zones.

In this manner, the solid wall defined tip 38 provides for a continuous seal against both static and dynamic forces.

In transitioning from a closed to an open state, one skilled in the art should appreciate that the opposite of that described above occurs.

Although the present invention has been described in connection with specific examples and embodiments, those skilled in the art will recognize that the present invention is capable of other variations and modifications within its scope. These examples and embodiments are intended as typical of, rather than in any way limiting on, the scope of the present invention as presented in the appended claims.

What is claimed is:

1. A valve assembly comprising:
a valve body comprising an inlet, an outlet, and an internal cavity;
a seal assembly comprising a solid wall defined tip situated coaxially within the internal cavity, thereby defining an internal fluid passageway within the valve body; and
an actuator assembly in sealing mechanical communication with the seal assembly for actuating the seal assembly;
wherein the defined tip comprises a flexible wall portion spaced from the actuator assembly to accept and retain a seal element and the internal cavity comprises a seat surface at an inlet end to seatingly and sealingly receive the defined tip.

2. The valve assembly of claim 1 wherein the defined tip is hollow.

3. The valve assembly of claim 1 wherein the defined tip is machined.

4. The valve assembly of claim 1 wherein the internal cavity is rounded.

5. The valve assembly of claim 1 wherein the defined tip is fabricated from a thermoplastic material.

6. The valve assembly of claim 1 wherein the defined tip is fabricated from a material selected from the group consisting of PTFE and TFM.

7. The valve assembly of claim 1 wherein the defined tip is fabricated from a thermoset material.

8. The valve assembly of claim 1 wherein the seal element is an o-ring.

9. The valve assembly of claim 1 wherein the defined tip further comprises at least one corrugation.

10. The valve assembly of claim 1 wherein the flexible wall portion occurs before a tip end.

11. The valve assembly of claim 1 wherein the seal assembly further comprising a shaft having a second threaded end and an opposite first threaded end, an anti-rotation oblong transverse channel located therebetween, and a dowel pin received by the transverse channel; wherein the first threaded end threadably receives the defined tip and the second threaded end threadably receives the actuator assembly.

12. The valve assembly of claim 1 wherein the body is a multiple valve manifold.

13. A seal assembly for use inside a valve body comprising a solid wall defined tip coaxially situated within the valve body to define an internal fluid passageway within the valve body; the defined tip comprising a seal element retained within a flexible wall portion.

14. The seal assembly of claim 13 wherein the defined tip is hollow.

15. The seal assembly of claim 13 wherein the defined tip is machined.

16. The seal assembly of claim 13 wherein the defined tip is fabricated from a thermoplastic material.

17. The seal assembly of claim 13 wherein the defined tip is fabricated from PTFE.

18. The seal assembly of claim 13 wherein the defined tip is fabricated from a thermoset material.

19. The seal assembly of claim 13 wherein the seal element is an o-ring.

20. The seal assembly of claim 13 wherein the defined tip further comprises at least one corrugation.

21. The seal assembly of claim 13 further comprising a shaft having a second threaded end and an opposite first threaded end, an anti-rotation oblong transverse channel located therebetween, and a dowel pin received by the transverse channel; wherein the first threaded end threadably receives the defined tip.

22. A method of sealing a valve comprising actuating an actuator assembly to move a seal assembly axially inward within a valve body; wherein
the valve body comprises an inlet, an outlet, and an internal cavity;
the seal assembly comprises a solid wall defined tip situated coaxially within a valve body internal cavity, thereby defining an internal fluid passageway within the valve body; and
the actuator assembly is in sealing mechanical communication with the seal assembly; and
the defined tip comprises a flexible wall portion spaced from the actuator assembly to accept and retain a seal element and the internal cavity comprises a seat surface at an inlet end to seatingly and sealingly receive the defined tip.

23. The method of claim 22 wherein the seal assembly further comprises a shaft having a second threaded end and an opposite first threaded end, an anti-rotation oblong transverse channel located therebetween, and a dowel pin received by the transverse channel; wherein the first threaded end threadably receives the defined tip and the second threaded end threadably receives the actuator assembly.
